(19) United States
(12) Patent Application Publication
(10) Pub. No.: US 2008/0045236 A1
(43) Pub. Date: Feb. 21, 2008

(54) Methods and apparatus for gathering and delivering contextual messages in a mobile communication system

(76) Inventors: Georges Nahon, San Francisco, CA (US); Gabriel Sidhom, Mill Valley, CA (US)

Correspondence Address: GAZDZINSKI & ASSOCIATES, 11440 WEST BERNARDO COURT, SUITE 375, SAN DIEGO, CA, 92127, US

(21) Appl. No.: 11/506,690

(22) Filed: Aug. 18, 2006

(51) Int. Cl. H04Q 7/20

(52) U.S. Cl. 455/456.1

(57) ABSTRACT

Methods and apparatus for delivering personalized (e.g., contextual) messages to a user that meets certain geographic, affiliation/metadata, timing, and/or or other criteria. These messages are geographically and logically persistent, and can be left by members of the user's social or “buddy” network, individuals, institutions, the user's service provider(s), or even advertisers or others seeking a commercial opportunity. These messages can be rendered in the form of voice, video, audio (e.g., MP3), text and graphics delivered to mobile phones, PDA's or other devices with network connectivity. Exemplary embodiments of the invention incorporate existing geo-localization technologies such as GPS embedded in these mobile platforms, or triangulation via signals from the cellular/PCS networks, IP addressing, presence in ad hoc networks, cell ID, E911/E112, Time of Arrival (TOA), Time Difference of Arrival (TDOA), Observed Time Difference (OTD) and Angle of Arrival (AOA).

### RELATED APPLICATIONS

This application is related to co-pending U.S. patent application Ser. No. 11/317,473 filed Dec. 22, 2005 entitled “Methods And Apparatus For Organizing And Presenting Contact Information In A Mobile Communication System”, and also co-pending U.S. patent application Ser. No. 11/026,421 filed Jan. 31, 2004 entitled “Method for interacting with automated information agents using conversational queries”, both of which are incorporated herein by reference in their entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of Invention

The present invention is related to the field of mobile communications. More particularly, the present invention is directed to a method and apparatus for gathering and delivering contextual messages in a mobile communications network; e.g., cellular telephone network.

2. Description of Related Technology

Mobile communications devices (MCDs) such as cellular telephones, smartphones and personal information managers (PIMs) such as the Blackberry™ device manufactured by RIM typically exchange messages with one or more other users. These messages are typically text messages, but may also be images, video, audio or any combination thereof. MCD users typically receive messages via a wireless interface and view or hear the messages via one or more output devices such as a display screen or speaker. Users may generate “text” messages for transmission to others via a keyboard, keypad or other input device (e.g., roller wheel, stick, mouse, etc.) the use of which is well known in the art. These text messages may also include pictures, sounds or other media either embedded therein or attached thereto.

As noted above, the messages exchanged via mobile communication devices are typically exchanged using a wireless interface. Communication is typically conducted over the wireless interface using radio frequency (RF) electromagnetic signals. The RF signals are often processed in accordance with one or more know communications standards such as without limitation GSM, IS-95, TDMA, AMPS, CDMA2000, W-CDMA, IEEE 802.11 (WiFi), IEEE 801.15, IEEE 802.16, or Bluetooth™, the use of which is well known in the art, although any wireless interface may be employed. Other wireless interfaces such as millimeter wave, infrared, optical or laser may also be employed.

Many modem MCDs also include position location capability. That is, the MCD can determine its current geographical location. The current location is typically determined via the Global Positioning System (GPS) and its associated satellite constellation, the construction and use of which is well known in the art. The location information may be used for reporting the user's location during emergency calls, or it may be used for providing services such as navigation. For example, the FindMe service offered by Nextel™ provides maps and other directional services based on the current location of the user as reported by the mobile communication device.

Other approaches to position location may also be employed, such as where existing infrastructure of the bearer network (e.g., base stations distributed throughout a cellular network or RAN) is used to geo-locate a specific subscriber based on their forward or reverse channel communications.

An internet service or theme that has become highly popular in recent times is so-called “social networking.” Social networking sites include e.g., MySpace™, LinkedIn™, Friendster™, Getmylook™, and aSmallWorld™. These social networking sites allow people to exchange information and messages with one another, and may be organized around the interests or attributes of their users. For example, LinkedIn is focused on business interests and connections. MySpace is more general, but has some focus on music. Getmylook has a fashion focus and aSmallWorld is an exclusive invitation-only network designed for socialites and other “Jet Set” people. These social networking sites have become highly popular and are used to exchange all sorts of information that is of interest to their members.

Another popular Internet service is “tag” based information storage. The most well know of these tag-based storage sites is Flickr. Flickr is a tag-based digital photograph site that allows people to store their photos with test tags that describe some attribute of the picture and can be searched on by other users. That is, a tag in this context comprises a word or other identifier that may be searched on by other users to find material of interest (e.g., metadata).

“Friend contact” services are also known in the prior art. For example, the service provided by Dodgeball.com (Google Inc.) allows users to contact their friend via text messaging; users enter their friend or “buddy” lists, and then send a communication to the server indicating their present location. The service then sends out messages to the persons listed on the user's list, thereby notifying them of the user's present location. This service, however, suffers from several disabilities including the inability of a user to know the locations of his/her friends, family, buddies, etc. Rather, the Dodgeball approach merely broadcasts information based on the initiating user's location, and the user regarding which the information was broadcast is provided no information as to the status or location of the persons on his/her list that are receiving the messages. It also suffers from requiring too much user manual entry, which can become very tedious, especially in the case of larger contact lists.

With the adoption of 3G and other mobile communication services (such as WAP), MCDs have mobile access to the Internet and all the services associated therewith, including social networking, tag-based database, and friend contact services. Additionally, as mentioned above, MCDs now typically include position location services as well as messaging services.

Given the need for ever-more useful services in the mobile communications sector, it would be highly desirable to provide social networking, tag-based, and friend contact functionality that take greater advantage of the existing capabilities of MCDs, including their inherent mobility and position location and messaging functionality.

### SUMMARY OF THE INVENTION

The present invention satisfies the foregoing needs by providing, inter alia, methods and apparatus for gathering and delivering contextual messages in a mobile communications network.

In accordance with one aspect of the invention, a method for operating a mobile communications network is provided. In one embodiment, the network includes a contextual message server and a mobile communications device (MCD) communicating with the contextual message server via at least a wireless link, and the method of operating the mobile communications network comprises: detecting a location and an affiliation of the mobile communication device; identifying contextual messages in the contextual message server having location and affiliation parameters that match the detected location and affiliation, thereby generating a set of identified contextual messages; transmitting the set of identified contextual messages from the contextual message server to the mobile communication device.

In one variant, the affiliation includes membership in a social network, a subscription to a restaurant review service, or selection of a historical information tour, and is determined based at least in part on a metadata tag.

In another variant, the contextual message server stores the affiliations of a plurality of mobile communication devices associated with respective ones of different users.

In yet another variant, the identification is performed by determining if the location of the MCD is within a prescribed distance of the location associated with the contextual message. The prescribed distance can be specified by the user via input into the MCD, or via another source or mechanism. Alternatively, the identification is performed by determining if the location of the MCD is within a prescribed geographic area of the location associated with the contextual message, the geographic area optionally being irregular in shape.

In still another variant, the method further comprises transmitting a request from the MCD to the contextual message server, the request including an affiliation, and the request indicating that the contextual message server should send any contextual messages to the MCD that have the same location and affiliation.

In a second aspect of the invention, a method for operating a contextual message server in a network that includes a wireless link to a mobile communication device is disclosed. In one embodiment, the method comprises: storing a contextual message, and an associated message location and affiliation for the contextual message; receiving mobile communication device location and mobile communication device affiliation information; evaluating the message location and affiliation with the mobile communication device location and mobile communication device affiliation; and transmitting the contextual message to the mobile communication device via the wireless link.

In one variant, the mobile communication device location and mobile communication device affiliation information is received by the server from a proxy of the mobile communication device. In another variant, the mobile communication device location and mobile communication device affiliation information is received from the mobile communication device by way of a wireless network.

In another variant, the method further comprises: receiving a new contextual message from an external source, the new contextual message having associated location and affiliation information; and storing the new contextual message for comparison with future mobile communication device location and affiliation information. The external source might comprise a second mobile communication device, a social networking service, restaurant review or guide service, etc. The contextual messages include metadata, the metadata comprising at least one of: (i) provenance information, and (ii) time of creation information.

In another variant, the act of evaluating comprises matching at least portions of the message location and affiliation with the mobile communication device location and mobile communication device affiliation. The matching is performed by determining if the location of the MCD is within at least one of: (i) a prescribed distance of, and (ii) a designated irregularly shaped area of the location associated with the contextual message.

In yet another variant, the method further comprises transmitting a request from the MCD to the contextual message server, the request including an affiliation, and the request indicating that the contextual message server should send any other or subsequent contextual messages to the MCD that have the same location and affiliation.

In a third aspect of the invention, a method for operating a mobile communications device (MCD) is disclosed. In one embodiment, the method comprises: determining a location associated with the mobile communications device; transmitting the location via a wireless interface to a message server; and receiving a message from the server based at least in part on the location and an affiliation of the mobile communication device. In one variant, the mobile communications device stores the affiliation and transmits the affiliation to the message server, and the location comprises a proximity to a reference point. The reference point can be fixed or substantially mobile.

In a fourth aspect of the invention, a communications network for delivering contextual messages is disclosed. In one embodiment, the network comprises: contextual message server apparatus adapted to: store contextual messages and location and affiliation information associated therewith; receive mobile communication device (MCD) location information; match contextual messages to the MCD location information; and transmit matched contextual messages; and at least one MCD adapted to: interface with the contextual message server via a wireless link; determine the MCD location information; transmit the MCD location information to the contextual message server apparatus; and receive the matched contextual messages from the server apparatus.

In a fifth aspect of the invention, a mobile communications device adapted for at least receiving contextual messages is disclosed. In one embodiment, the mobile communication device comprises: wireless interface apparatus adapted to communicate data with at least one other device; location apparatus adapted to determine location information; a memory for storing software instructions; a microprocessor in data communication with the memory and adapted to execute the software instructions, and control the wireless interface apparatus; wherein the software instructions cause the device to: transmit the location information to a message server, and receive messages having at least location information that matches that of the transmitted location information.

In another embodiment, the mobile communications device (MCD) comprises: wireless interface apparatus adapted to communicate data with at least one other device, the at least one other device being adapted to determine the location of the MCD based on the communication of data; a memory for storing software instructions; a microprocessor in data communication with the memory and adapted to execute the software instructions, and control the wireless interface apparatus; wherein the software instructions cause the device to receive messages having at least location information that matches that of the of the location determined by the at least one other device.

In one variant, the at least one other device comprises a wireless network node, and the determination of the location of the MCD comprises determining membership in an ad hoc wireless network.

In another variant, the at least one other device comprises a cellular network base station or mobile switching center (MSC).

In a sixth aspect of the invention, a contextual message server for storing contextual messages is disclosed. In one embodiment, the contextual message server comprises: memory configured to store software instructions; a microprocessor in communication with the memory and configured to execute the software instructions, wherein the software instructions cause the microprocessor to: maintain a database of contextual messages and associated locations and affiliations; receive mobile communication device location information; determine an affiliation for at least one mobile communication device for which the location information has been received; identify at least one message from the database based at least in part on the affiliation and the location information; and transmit at least a portion of the at least one matching message to the at least one mobile communication device.

In one variant, the affiliation comprises a search term, and the identification of the at least one message comprises identifying the at least one message via the search term matching metadata associated therewith.

These and other features of the invention will become apparent from the following description of the invention, taken in conjunction with the accompanying drawings.

### BRIEF DESCRIPTION OF THE DRAWINGS

FIG. 1 is a plan view of an exemplary mobile communications device useful with the present invention.

FIG. 1a is a functional block diagram of a mobile communications device configured in accordance with one embodiment of the invention.

FIG. 2 is a block diagram of an exemplary mobile communications network configured according to one embodiment of the invention.

FIG. 2a is a functional block diagram of a contextual information server configured in accordance with one embodiment of the invention.

FIG. 3 is a logical flow chart illustrating an exemplary server-side process utilized in accordance with one embodiment of the invention.

FIG. 3a is a logical flow chart illustrating an exemplary method of operating a server according to the present invention.

FIG. 4 is a logical flow chart illustrating an exemplary client-side process performed in accordance with one embodiment of the invention.

FIG. 5a is a logical flow chart illustrating an exemplary embodiment of existing tag (metadata) processing according to the invention.

FIG. 5b is a logical flow chart illustrating an exemplary embodiment of tag processing according to the invention when no existing tags are present.

### DETAILED DESCRIPTION OF THE INVENTION

Reference is now made to the drawings wherein like numerals refer to like parts throughout.

As used herein, the terms “network” and “bearer network” refer generally to any type of telecommunications or data network including, without limitation, wireless and Radio Area (RAN) networks, hybrid fiber coax (HFC) networks, satellite networks, telco networks, and data networks (including MANs, WANs, LANs, WLANs, internets, and intranets). Such networks or portions thereof may utilize any one or more different topologies (e.g., ring, bus, star, loop, etc.), transmission media (e.g., wired/RF cable, RF wireless, millimeter wave, optical, etc.) and/or communications or networking protocols (e.g., SONET, DOCSIS, IEEE Std. 802.3, ATM, X.25, Frame Relay, 3GPP, 3GPP2, WAP, SIP, UDP, FTP, RTP/RTCP, H.323, etc.).

As used herein, the terms “radio area network” or “RAN” refer generally to any wireless network including, without limitation, those complying with the 3GPP, 3GPP2, GSM, IS-95, IS-54/136, IEEE Std. 802.11, Bluetooth, WiMAX, IrdA, or PAN (e.g., IEEE Std. 802.15) standards. Such radio networks may utilize literally any air interface, including without limitation DSSS/CDMA, TDMA, FHSS, OFDM, FDMA, or any combinations or variations thereof.

As used herein, the terms “Internet” and “internet” are used interchangeably to refer to inter-networks including, without limitation, the Internet.

As used herein, the terms “mobile client device” and “MCD” include, but are not limited to, personal digital assistants (PDAs), handheld computers, personal communicators, J2ME equipped devices, cellular telephones, “SIP” phones, personal computers (PCs) and minicomputers, whether desktop, laptop, or otherwise, or literally any other device capable of receiving video, audio or data over a network.

As used herein, the term “network agent” refers to any network entity (whether software, firmware, and/or hardware based) adapted to perform one or more specific purposes. For example, a network agent may comprise a computer program running in server belonging to a network operator, which is in communication with one or more processes on a client device or other device.

As used herein, the term “application” refers generally to a unit of executable software that implements a certain functionality or theme. The themes of applications vary broadly across any number of disciplines and functions (such as communications, instant messaging, content management, e-commerce transactions, brokerage transactions, home entertainment, calculator etc.), and one application may have more than one theme. The unit of executable software generally runs in a predetermined environment; for example, the unit could comprise a downloadable Java Xlet™ that runs within the Java™ environment.

As used herein, the term “computer program” or “software” is meant to include any sequence or human or machine cognizable steps which perform a function. Such program may be rendered in virtually any programming language or environment including, for example, C/C++, Fortran, COBOL, PASCAL, assembly language, markup languages (e.g., HTML, SGML, XML, VOXML), and the like, as well as object-oriented environments such as the Common Object Request Broker Architecture (CORBA), Java™ (including J2ME, Java Beans, etc.) and the like.

As used herein, the term “server” refers to any computerized component, system or entity regardless of form which is adapted to provide data, files, applications, content, or other services to one or more other devices or entities on a computer network.

As used herein, the term “speech recognition” refers to any methodology or technique by which human or other speech can be interpreted and converted to an electronic or data format or signals related thereto, including without limitation, MFCC (Mel Frequency Cepstral Coefficients) or cochlea modeling, phoneme/word recognition, HMM (hidden Markov modeling), DTW (Dynamic Time Warping) or NNs (Neural Networks).

As used herein, the terms “microprocessor” and “digital processor” are meant generally to include all types of digital processing devices including, without limitation, digital signal processors (DSPs), reduced instruction set computers (RISC), general-purpose (CISC) processors, microprocessors, gate arrays (e.g., FPGAs), PLDs, reconfigurable compute fabrics (RCFs), array processors, and application-specific integrated circuits (ASICs). Such digital processors may be contained on a single unitary IC die, or distributed across multiple components.

As used herein, the term “integrated circuit (IC)” refers to any type of device having any level of integration (including without limitation ULSI, VLSI, and LSI) and irrespective of process or base materials (including, without limitation Si, SiGe, CMOS and GaAs). ICs may include, for example, memory devices (e.g., DRAM, SRAM, DDRAM, EEPROM/Flash, ROM), digital processors, SoC devices, FPGAs, ASICs, ADCs, DACs, transceivers, memory controllers, and other devices, as well as any combinations thereof.

As used herein, the term “memory” includes any type of integrated circuit or other storage device adapted for storing digital data including, without limitation, ROM. PROM, EEPROM, DRAM, SDRAM, DDR/2 SDRAM, EDO/FPMS, RLDRAM, SRAM, “flash” memory (e.g., NAND/NOR), and PSRAM.

As used herein, the term “display” means any type of device adapted to display information, including without limitation CRTs, LCDs, TFTs, plasma displays, LEDs, and fluorescent devices.

As used herein, the term “database” refers generally to one or more tangible or virtual data storage locations, which may or may not be physically co-located with each other or other system components.

As used herein, the term “image” refers to both still images and video or other types of graphical representations of visual imagery. For example, an image might comprise a JPEG file, MPEG or AVC-encoded video, or rendering in yet another format.

As used herein, the term “cellular” includes any form of cell-based mobile communications system including cellular telephones, “walkie-talkie” devices (such as those marketed by Nextel and Motorola Corporations, and so-called PTx (“push-to-anything”) devices such as the exemplary PTT (push-to-talk over cellular) devices which establish and tear down SIP or other communications sessions as part of their protocol.

As used herein, the terms “position” and “coordinate(s)” refers to any method of determining, estimating or predicting the position of a device, user, or object/location. For example, coordinates for a position determination or “fix” may comprise a set of Global Positioning System (GPS) or Universal Transverse Mercator (UTM) coordinates, latitude/longitude, polar coordinates, or a triangulation via cellular base stations or wireless access points “beacons”, celestial reference, or even a LORAN or similar navigation device fix. Coordinates for a position estimation (“EP”) may come from other devices such as passive inertial navigation systems (e.g., Electrostatically Supported Gyroscopic Navigator or ESGN), or extrapolation from a previous fix based on speed, direction, etc. Similarly, location prediction can be accomplished according to any number of methods, such as extrapolation based on a set of input parameters (e.g., speed, direction, etc.) or “personal” tracking approaches, such as without limitation that described in United States Patent Publication No. 20050143909 to Orwant published Jun. 30, 2005 entitled “Technique for collecting and using information about the geographic position of a mobile object on the earth's surface”, which is incorporated by reference herein in its entirety. As described in greater detail subsequently herein, the term “location” may include coordinates or position, but is also much broader and may include without limitation actual or physical proximity, psychographic proximity, and so forth.

### Overview

In one exemplary aspect, the present invention comprises apparatus and methods for delivering personalized contextual messages to a user once they meet certain geographic or other criteria; e.g., at the moment that they enter the sensing range of a particular location which has associated with it one or more messages relevant to that location. These messages are “left” by members of the user's social or “buddy” network, individuals, institutions, the user's service provider(s), or even advertisers or others seeking a commercial opportunity. These messages can be rendered in the form of voice, video, audio (e.g., MP3), text and graphics delivered to mobile phones, PDA's or other devices with network connectivity.

Exemplary embodiments of the invention incorporate existing geo-localization technologies such as GPS embedded in these mobile platforms, or triangulation via signals from the cellular/PCS networks, to effect part of the invention's functionality. The service's relevance and usefulness is to some degree related to the precision of its geo-location calculation, and hence the comparatively high degree of precision of these techniques (or others available) is advantageously leveraged for this purpose.

To provide timely and accurate positional information regarding the user and other contacts in (or outside) the network, a multi-source approach may be used, as well as algorithms specifically adapted to evaluate the information from each source (and the relevance of the source at any given time or context) to arrive at an optimized value. Myriad different data sources can be used by the system, including e.g., GPS/Assisted GPS, cellular base station triangulation/ranging, IP addressing and presence in ad hoc networks, Cell ID, Enhanced 911 (in the U.S.), E112 (in Europe), Time of Arrival (TOA), Time Difference of Arrival (TDOA), Observed Time Difference (OTD) and Angle of Arrival (AOA).

In one aspect, the aforementioned messages “left” for a user or entity are geographically and logically persistent, in effect “hanging over” a given location to be retrieved by target users (e.g., interested users, those meeting a demographic or other such filtering criteria, or those to which the message is particularly directed) upon being apprised by their mobile client device that there are one or more messages associated with the location. The messages can be identified by their provenance—e.g., their social network or another source—depending on the preferences and opt-in choices set by users of the service/network.

In another aspect, the present invention allows for “communal posting” of information, and retrieval and updating of information associated with geographical or other locations. This information also includes information about the relative distance of social network members from a given tagged location.

The principles of the present invention can also be extended to: (i) non-fixed locations (e.g., those determined ad hoc or otherwise yet which can be definitively associated with a geographic or other point of reference as a function of time or other parameter), and (ii) “logically proximate” locations (e.g., a user-centric or logical/psychographic frame of reference which can then be converted to a geographic or other frame of reference, such as when a target user comes within proximity to a second user's mobile phone, a second user's friend's mobile phone, a mobile WiFi or Bluetooth node, etc.).

The present invention is also advantageously flexible in its deployment; many if not all of the functions can be performed at a centralized server, at a third party site or provider, or even on the user's mobile device itself. It can also be readily layered on existing systems, and even adapted to make use of indigenous protocols of the network and mobile device (e.g., WAP, SIP, etc.).

### Detailed Description of Exemplary Embodiments

Exemplary embodiments of the apparatus and methods of the present invention are now described in detail. While various functions are ascribed herein to various systems and components located throughout a network, it should be understood that the configuration shown is only one embodiment of the invention, and performing the same or similar functions at other nodes or location in the network may be utilized consistent with other embodiments of the invention.

Also, the various systems that make up the invention are typically implemented using software running on semiconductor microprocessors (integrated circuits) or other computer systems the use of which is well known in the art. Similarly, the various processes described here are also preferably performed by software running on a microprocessor, although other implementations including firmware, hardware, and even human performed steps, are also consistent with the invention.

It will further be appreciated that while described generally in the context of a network providing service to a customer or consumer end user domain, the present invention may be readily adapted to other types of environments including, e.g., enterprise (e.g., corporate), public service (non-profit), and government/military applications. Myriad other applications are possible.

Lastly, while certain embodiments are described in the context of well-known Jabber client/server protocols, Internet Protocol (described in, inter alia, RFC 791 and 2460), the Wireless Application Protocol (WAP), or Session Initiation Protocol (SIP), it will be appreciated that the present invention may utilize other types of transport mechanisms, protocols (and in fact bearer networks to include other internets and intranets) to implement the described functionality.

### Mobile Communications Device and Network

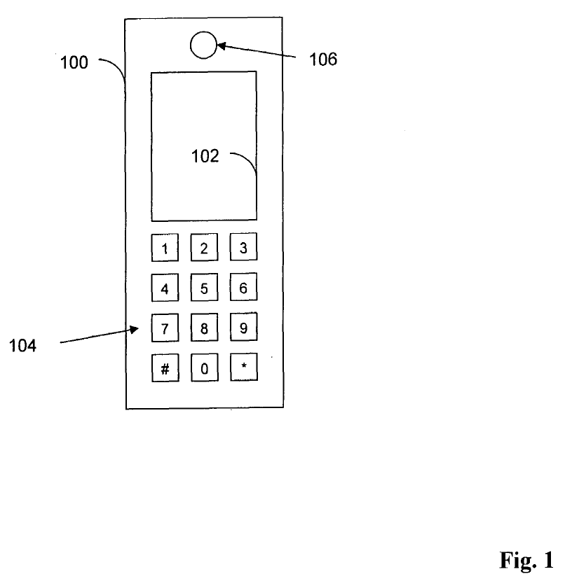

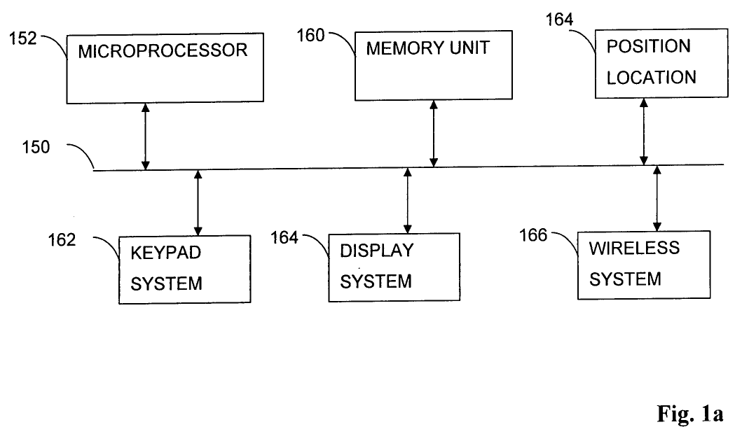

FIG. 1 is a simplified block diagram of a mobile communications device configured in accordance with one embodiment of the invention. The mobile communications device (MCD) 100 is a computerized device that includes a keypad 104 (or other input device such touch screen or pen-based input, or speech recognition capability) for the input of information such as telephone numbers, messages and contacts names. Other input system such as scroll wheel, miniature “joystick”, or jog dial (not shown), may also be used, the construction and use of which is well known in the art.

A display 102 is also provided on the MCD 100 for viewing information, which may include, for example, text, graphics, iconic representations, video, etc. The display device may be, for example, LCD, thin-film transistor (TFT), plasma, or even a cathode ray tube (CRT) of the type well known in the art. The display may also comprise soft function keys (SFKs) with touch-screen capability generated by the MCD for implementing various functions such as entering various operating modes, shortcuts, etc. MCD also include digital camera 106 that is used to capture digital images for storage on the phone or transmission to others. Camera 106 may also be used to take video for streaming or video clips that may be stored and exchanged later.

An audio card or module with speaker(s), earpiece, headset jack, etc. may also be provided as part of the MCD 100, such as for listening to music, the audio portion of video, text-to-speech (TTS) messages, and so forth.

The MCD 100 comprises, in the exemplary embodiment, a cellular telephone or “smartphone”, but any other type of mobile or nomadic client device may be employed as desired. For example, a laptop computer, hand-held computer or PDA with a wireless interface connection such as an IEEE Std. 802.11 “WiFi” or 3G (i.e., UMTS, 3GPP, 3GPP2, etc.) enabled computer card may comprise the MCD 100. A substantially fixed communications device (e.g., a desktop PC or the like) may also be employed consistent with the invention; however the benefit provided by the invention will be somewhat reduced due to the lack of mobility of such a substantially fixed communication device. “Fixed” devices located on substantially mobile platforms (e.g., cars, trucks, etc.) may also be utilized. For example, the MCD 100 may comprise an integrated circuit or dashboard-mounted device in a vehicle.

The input devices on MCD 100 such as keypad 104 may be used to enter text messages, and append or integrate any other content to be transmitted as well (e.g., file attachments, audio clips, graphics, etc.). These text messages may then be transmitted to other users by way of a one or more interfaces in the MCD including the wireless interface; e.g., cellular channel. The recipients of these messages may be other MCDs or may be computer systems such as desktop or laptop personal computers, whether “in network” or in another network. Audio and/or visual “messages” may also be generated by the camera or the microphone inputs for transmission to other systems.

MCD 100 may also receive text messages from other users via one or more of its interfaces including the wireless interfaces. These text messages may then be viewed on display 102. The messages may also be stored for later viewing. Audio or visual messages may also be heard via a speaker (or earphone, headset, etc.) or viewed on the display 102. Messages may be stored for later review.

The MCD 100 preferably interfaces with a base station or other access point via radio frequency electromagnetic signals (RF signals) that are modulated in accordance with one or more communications standards or protocols. Examples of useful standards include, inter alia, GSM, CDMA-2000, W-CDMA, TDMA (IS-54 and IS-136), PCS, UMTS, EDGE, and IEEE 802.16, 802.15 or 802.11. The use of other standard or non-standard wireless interfaces (e.g., EPCGEN2 compliant RFID) is also consistent with other embodiments of the invention, which is in no way limited to any particular standard or air interface. Alternate embodiments, for example, may use GHz-band satellite transceivers or infrared, laser or magnetic (inductance) interfaces.

Typically, the MCD 100 includes a microprocessor and integrated circuit or other memory for storing programs that are executed by the microprocessor (not shown). The software running on the microprocessor controls the operation of the MCD including processing input, generating display data and generating messages to be transmitted via the wireless link.

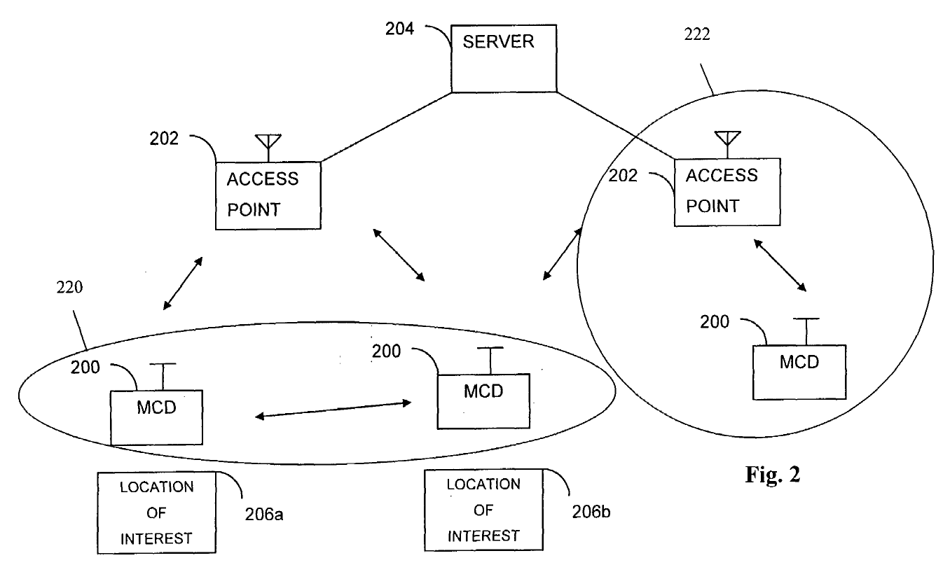

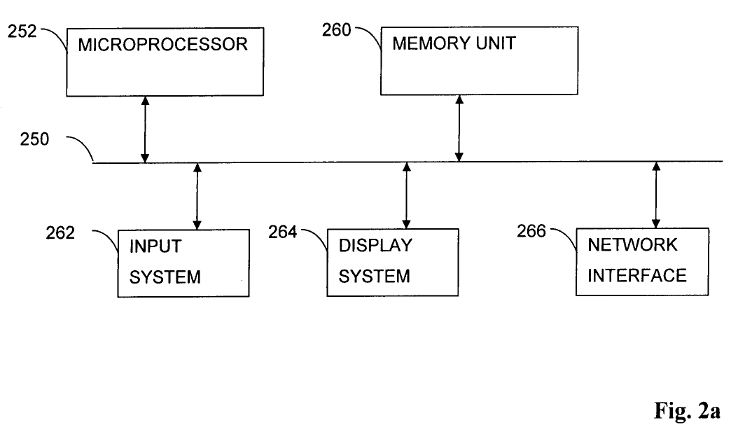

The client device (MCD 100) runs the client application (“client”). The server 204 of FIG. 2, et seq. (described subsequently herein) includes its own software application, or a server portion of a distributed application (DA), that processes the client requests, and sends messages to the corresponding client process. It will be appreciated that while described in terms of a client application and a server application, the present invention is typically embodied in the form of corresponding protocol stacks resident on each of the communicating machines. These stacks are configured to include, inter alia, an application (user) layer, and physical/network) layers that allow interface between the two devices to occur over the interposed bearer medium. Session and security layer processes (e.g., WSP and WTLS in a WAP environment) may also be interposed in the stack of each device, as well as other types of functionality well known to those of ordinary skill in the art.

FIG. 1a is a block diagram of a mobile communications device configured in accordance with one embodiment of the invention. The microprocessor 152 is coupled to memory unit 160 via the bus 150. The memory unit 150 typically includes fast access storage elements including random access memory (DRAM, SRAM), read-only memory (ROM) as well as slower access memory systems including flash memory and disk drive storage. The bus 150 also electronically couples the keypad system 162, display system 164, position location unit 164 and wireless system 166 to the other components of the system, as is well known in the art.

During operation, software instructions stored in the memory unit 160 are applied to the microprocessor 152 (which also may contain its own internal program/data/cache memory), which in turn controls the other components such as the keypad system 162, display system 164 and wireless system 166. The software causes the systems to perform the various functions described throughout this application. Separate dedicated ICs or ASICs may also be used for one or more of these functions, such as where a separate RF communications chipset or suite is used in conjunction with a host or baseband processor.

FIG. 2 is a highly simplified block diagram of a mobile network configured in accordance with one embodiment of the invention. A contextual message server 204 is coupled to one or more access points 202. These access points 202 interface with MCD's 200 via a wireless interface. It should be clear that networks, especially those of the wireless variety, will often incorporate many more than two access points, and that multiple servers 204 may also be employed. Accordingly, FIG. 2 is merely illustrative of the broader principles in this regard. Additionally, FIG. 2 shows multiple locations of interest 206a-b. “Locations of interest” may be for example restaurants, tourist destinations, places of business, offices, clubs, shopping centers or other places of interest to one or a group of people. Such locations of interest may also be moving locations (e.g., a given user's mobile device, PDA, etc., their car, aircraft, the moving location of a weekly or periodic event, such as a club meeting, etc.) or those specified ad hoc (e.g., a WiFi hotspot or AP/STA network, Bluetooth piconet, etc.).

In some embodiments of the invention, the MCD 200 may interface with only one access point 202 at any given time thus forcing a “hard handoff”. In other embodiments of the invention, MCD 200 may interface simultaneously with two or more access points to allow for “soft hand-off.” Other methods for hand-off and hand-over well known to those of ordinary skill in the wireless and cellular arts are also consistent with various embodiments of the invention.

The configuration shown may be, for example, a cellular telephone network (e.g., 3G, GSM, or UMTS). In that case, access points 202 may be “base stations” that communicate with MCD 200 using modulated RF signals modulated in accordance with one of the many mobile wireless communication standard, many of which have been previously mentioned herein. Alternatively, the access points 202 may be IEEE-802.11a/b/g/n (“Wi-Fi”) style access points providing nomadic wireless Internet access. The access points 202 may also be IEEE-802.16 (“Wi-Max”) access points that deliver high speed internet access in both fixed or mobiles formats. The use of other wireless interfaces (including those described throughout this application) is consistent with various embodiments of the invention. Also, other network configurations and topologies are consistent with the use of some embodiments of the invention, including non-centralized networks, satellite based networks, or even highly localized PANs (personal area networks).

The server 204 may be a single machine or process, or a network of machines/processes functioning together (whether physically proximate or disparate). A logical communication stream is established between the corresponding client and server processes, either uni-directionally or bi-directionally as required, in order to conserve communication bandwidth.

As shown in FIG. 2, the various mobile devices may form ad hoc networks 220, 222, either directly between themselves (network 220) or between one or more mobile devices and an access point 202 (network 222). For example, a “master/slave” relationship may be created in a Bluetooth network, or an AP/STA relationship in an 802.11 network. These roles can switch as well, such as where a Bluetooth master undergoes an identity change during operation.

The access point(s) 202 in such case may also not be part of the underlying cellular network per se, but rather merely in communication therewith via a portal, gateway, router, or other such intermediary networking device. Other types of ad hoc networks and protocols may be used as well.

During operation MCDs 200 perform position or other “location” functions to determine their absolute (or relative) location. This location may be performed using GPS, triangulation, or other techniques well know in the art. In some embodiments (e.g., wherein relative position is used), it may be sufficient to merely know the range to an object, irrespective of its exact (relative) position. For example, where the system desires to deliver a message or posting to a second user who is proximate to a first (moving) user, it may be sufficient to simply know when the closest point of approach (CPA) is reached, and this falls within a predetermined criterion (e.g., 500 meters).

In still other embodiments of the invention, the presence of a user's MCD within an ad hoc network 220, 222 can be used to provide location information. For example, if the server 204 or its proxy knows that a given MCD is part of an ad hoc network coupled to a particular WiFi access point 202, then the server/proxy can apply heuristics or a priori rules regarding the physical location of that MCD relative to the user being served or a fixed location, since the location of the access point is known by the server/proxy. While somewhat less precise than GPS or triangulation, this approach advantageously obviates many of the messages between the server and MCDs necessary to update the latter's position. Determination of presence within a given ad hoc network can be accomplished by, inter alia, IP address, MAC, Bluetooth and WiFi “beacon” functions can also be exploited to provide position or proximity information.

The MCD location may be reported to the server 204 via messages transmitted over the wireless interface via the access points 202. In other cases, the coverage of the access point 202 may be small enough that any communication with that access point will constitute being at a particular location. In this case, the server 204 will monitor for links to that particular access point 202 and take action based thereon. Other alternative or “out of band” communication channels may also be used for communication between the MCDs and the access points. For example, a power control or other ancillary signaling channel or the like not used for in-band communications may be used for this purpose.

Additionally, the MCDs 200 may store “affiliation” information about other MCDs or other users. This affiliation information may be input by users, or downloaded from other websites or information sources for such users. Affiliation information may comprise many types of information including, but not limited to, a “buddy list”, a social network, a membership, an interest list, nationality, regional affiliation, a tag, a service subscription, or literally any other attribute (or collection of attributes) of the user that will distinguish that user from other users.

The server 204 (or an associated network entity or database) may store the affiliation information of different MCDs 200 as well. A particular MCD 200 may upload or synchronize its affiliation information with the server 204, or the server 204 may be the primary storage location for this affiliation information. The affiliation information may be associated with an MCD 200 or a particular user, and the user would then place his personal information on the MCD to associate it with the particular affiliation information. The user may then advantageously move or migrate his/her user information from one MCD to another MCD at the user's discretion. This could be done using a “smart card” or, for example, simply logging in or out of the “identity” of the MCD.

In accordance with one embodiment of the invention, the server 204 also stores a database of contextual messages for delivery to other nodes or systems based on the particular context in which those systems are presented. This contextual information includes, inter alia, “location” and affiliation. That is, each contextual message will also have an associated location field and affiliation field. As previously noted, “location” information may be absolute, relative, based merely on proximity, etc. These contextual messages are typically text messages generated internally by the network operator or by other entities including other users, businesses, advertising entities (e.g., Google™ Ad Server), institutions, or government entities. Other meta-information about the message may also be stored including for example the source (provenance), time of entry and type.

In accordance with one embodiment of the invention, when the server 204 detects an MCD 200 at a particular “location”, it checks the contextual message database for messages associated with that location. In some embodiments of the invention, the server 204 will further check the affiliation of the MCD 200, and compare that with the affiliation associated with the contextual message(s) in the contextual message database. These operations may be conducted in a serial manner (so as to conserve processing bandwidth since not all locations will match, and hence no subsequent affiliation analysis is required), in parallel, or combinations/permutations thereof depending on the particular algorithm employed.

If the location and affiliation of a given message (or group of messages; messages may be “bundled” beforehand based on location/affiliation as well) match the location and an affiliation on the MCD 200, then server 204 transmits the contextual message to that MCD, preferably by way of the wireless network and link. The message is then viewed by the user of the MCD and/or stored for later use. It may also be forwarded to another entity; e.g., proxy for the MCD, etc.

In some variants, the server 204 will first transmit a short notice to the MCD 200 that contextual messages matching the users current location and affiliations are available. The user would then have the option, via input to the MCD, to receive the entire message. The user may also elect to receive a short summary or title of the message(s), indication of source (i.e., who posted it), and so forth in order to enable them to decide whether to download it or not. The server 204 would then forward the contextual message when the request to receive the message was received, typically via the wireless interface although another signaling interface or mechanism may be used (e.g., SMS message, WAP push, etc.).

Often, the contextual message comprises a text message with information related to the place where the MCD 200 is located. Additionally, the contextual message may also be associated with affiliation that is shared by the MCD. For example, if the MCD 200 is located near a restaurant, the contextual message may include information (e.g. reviews) or recommendations about that restaurant. The reviews may be from members of the MCD user's social network, from a review service to which the user subscribes, or even just other subscribers within the carrier (service provider) network. For example, Zagat® provides restaurant reviews as well as other information about destinations of interest. A user could subscribe or sign up for access these reviews and receive the contextual messages when they are proximate to a restaurant for which a review is available. This may also be used to alert or prompt them to the existence of the restaurant in the first place. Selective filtering based on theme, category, etc. can also be employed; e.g., “download all messages relating only to restaurants at or near this location”.

Other contextual messages could include information about a party or other social event, or an observation. For example, the observation could include a preferred menu selection at the restaurant made by a member of the user's social network (e.g., “try the lobster . . . it's great”). Alternatively, the observation could include a historical anecdote about the location.

Once the contextual message is received, the user can view or store the message (or forward it). In some cases the user may respond by adding their own comments or other annotations (e.g., camera phone pictures, audio clips, etc.) to the text message. This message could be forwarded back to the server for later transmission to other users. The message would include the corresponding location information and any affiliation information. Such messages will typically include source, or provenance, information as well.

In some instances, the message may be ad hoc or pre-stored statements from other members of the user's social network about the particular location. For example, a user could leave a message about an establishment indicating it is approved by other members of his/her social networking group, or that they should “stay away,” or “avoid at all cost.”

Attributes can also include “tags”, which are labels that indicate a topic or other attribute of interest of the user. For example, a user may be interested in historical churches. When the user passes a location with the tag “church,” a contextual message (or notice of such a message) may be delivered to the user. Or a user may be interested in public figure, and if a tag associated with that public was associated with the particular location, a message would be sent to that user contemporaneously (e.g. “Elvis performed here in 1969.”)

Linking between locations may also be used consistent with the invention. For example, a user may sign up for a “guided tour” of a city or facility. In this case, a user would receive directions to various locations of interests (e.g., via text message or other communication mode) along with information about those locations when the user arrived. This service could also be used for museums, zoos or other places of interest. These messages may be time-staggered and/or sequenced in a particular order, or delivered en masse.

Affiliation data under the present invention can also include user-specific or user customized information and attributes, to assist in delivering relevant contextual messages from friends, advertisers, etc.

The attributes can also include information from the user's calendar and/or contacts list in the MCD 200. For example, if a person on the users contact or buddy list is located in close proximity to the current location, a contextual message can be generated informing the user of an opportunity to meet that user. The user's calendar or datebook functions can also be accessed (either locally at the MCD, or remotely if such information is uploaded to the contextual server) to determine of a scheduling conflict exists. This can be “two way” in nature; i.e., both the user and the contact/buddy calendar functions can be accessed to determine if a conflict exists for either person.

The user may at any time elect to decide to discretionally or completely activate or deactivate the contextual messaging service; e.g., turn off after 6:00 pm, turn on only when within X miles of downtown San Diego, etc.

As noted elsewhere herein, the definition of “location” may vary significantly with different embodiments of the invention. For example, in some embodiments of the invention, the location can be defined as an area of a certain size; e.g., a ten-meter circle. In other instances, the location would be defined as a larger area, on the order of 50 meters from a particular coordinate. It may also include for example a relative distance (geographic proximity), or even logical or psychographic proximity (e.g., within X meters of one of the user's “buddies”). In other instances, the location could be a pre-existing feature, structure (e.g., building), address, block or city. Irregular shapes or cognitively associated regions such as neighborhoods could also be defined as locations e.g. “downtown”, “Southbeach” or “the historic district”.

The size of a particular location can vary, and/or be coupled with the type of location. For example, an internal location in a building could have a smaller “size” associated therewith, while an exterior or outdoor location could have a larger size, as might a moving location (e.g., car). This may also be made a function of the local features or topography; i.e., somewhere that has a clear view around it in all directions might be given a larger “size”, while obstructed or close-in points of interest might have a larger scale (smaller area). The size of the location may also simply vary with the size of the point of interest. Only when a user was within the location, as defined by the size of that location, would a matching contextual message be identified and transmitted.

In some embodiments of the invention, the size of some locations (including a “default” setting or settings based on the type of location/point of interest) can be specified by the user. This can be accomplished by selecting a configuration or preference parameter using the input/UI of the MCD, for example. A user could specify a preference for a larger “location” definition and thereby receive greater number of messages. Conversely a user could specify a preference for a smaller location and thereby receive a fewer number of messages all else being equal. Similarly, the user can specify one size for a first type, a second size for a second type, and so forth (e.g., 20 m for restaurants, 40 m for historical points of interest, etc.).

In other embodiments of the invention, advertisers or other entities can use this service to push personalized messages and information to the user on an opt-in basis (e.g., affirmative selection or rejection by the user). These could include information about offers or specials as well as promotionals/coupons or incentives. The service could be provided on a user fee basis, as a premium feature as part of a given subscription package or incentive program, or the source advertisers or other entities could finance the service themselves (e.g., on a per-delivery or per-view basis). Myriad other approaches will and permutations will be recognized by those of ordinary skill provided the present disclosure.

When a user want to leave one or more messages relating to a particular “location”, he/she can be connected to the server 204 through the Internet and/or by way of the wireless network, including sending SMS, WAP or other messages to leave text, voice, video or image content. In one embodiment, the user can specify the “size” of the location that should be associated with a given message or group of messages. Alternatively, the system can assign a default size based on the type of location as described above, and/or based on the type of message (e.g., “high priority” messages might be given a larger size than routine or ordinary traffic), or other parameter (such as psychographic proximity—one might want to assign a different area size to a family member than merely a professional or business acquaintance). The location associated with the message could be the current location of the MCD, or the user can specify a different location, or proximity, or other such location-related parameter.

A “bounceback” feature can also be employed within the MCD 100 (and server 204), wherein a scripted or unscripted “reply” is generated by the user and left for the originator of the first message. Advantageously, this function can be initiated by the receiving user regardless of their current location; the server 204 in the exemplary embodiment simply remembers the location and association information associated with a message, and when instructed to reply, leaves the reply message at the location of the original message (“location” in this context can mean a physical location, proximity to a reference point, etc. as previously described). Hence, a replying user might be nowhere near the original message location when this function is initiated, yet the server will leave the reply at the designated location regardless.

Advantageously, pre-formatted or scripted messages can be recalled and sent in a “one touch” fashion, such as a “reply” icon on a GUI or FFKISFK key on the MCD 100 that allows a rapid reply of a designated type (e.g., “Got your message . . . I'll get back to you ASAP” or the like).

By monitoring the location of MCDs 200 and providing contextual messages to the MCD depending on that location, the exemplary embodiment of the invention delivers personalized contextual messages, thereby providing increased utility to that user. This value is further enhanced by only providing message that have an affiliation that is also shared by that user. This increases the likelihood that the user will receive messages that are both useful and timely to that user. Contextual messages may be left by members of the user's social network, individuals, businesses, universities, other institutions, advertisers, and so forth. Messages can be voice, video, text and graphics delivered to mobile phones, PDA's or other devices with wireless connectivity, although it will be recognized that wireline connectivity may be used to practice the invention as well (such as where the user plugs into or logs onto a centralized communication node or device).

As noted above, in some embodiments of the invention, the contextual messages are not delivered unless the user issues a request from the MCD (so-called “deliver permissive”). That is, the user would arrive at a particular location, and then issue an affirmative request (or fail to acknowledge a “ping” or query from the server for such delivery within a prescribed period of time, etc.) for any contextual messages. The request issued by the user may be for just a certain type of message (e.g., those from a particular source, those of particular genre (as indicated by an associated message identification code or descriptor), for just the titles/sources of some or all of the messages, or for all messages with an affiliation shared by said user. The messages would then be delivered to the user for viewing on the MCD according to this delivery filter or mask function. Such masks can also be pre-stored within the server and/or MCD, (e.g., Profile 1, Profile 2, etc.), so that the user need not recreate them and can change between them rapidly if desired.

In accordance with a preferred embodiment of the invention, the messages are persistent and in effect “hang over” a given location, waiting to be retrieved by interested users upon being apprised by their device that there are one or more messages associated with the location (subject to any masking as previously described). The messages preferably are identified by their provenance—social network or other source—depending on the preferences and opt-in choices set by users.

Such messages may also have a predetermined or deterministic persistence or “lifetime”, such as where the relevance of the message is of finite duration. Hence, in one embodiment, the server 204 is configured to remove or filter messages based on a persistence parameter (e.g., duration of posting or availability), which can be specified by the message sender or source, the target user (receiver), or a union of both (i.e., Boolean logical “AND”). This persistence or duration can also be determined algorithmically; e.g., based on tags or metadata associated with the message, either in the form of: (i) explicit duration or persistence parameters present in the metadata, or (ii) evaluation of the metadata (e.g., one or more keywords, etc.). As an example, a message relating to a sporting event on Date XX/YY/ZZ might be filtered based on metadata containing such date, wherein the local clock reference indicates that Date XX/YY/ZZ has passed. Alternatively, the metadata might comprise “San Diego Chargers versus San Francisco 49'ers” as part of the metadata, and the algorithm is configured to consult one or more internal or external sources (e.g., schedules for the current football season) to determine that this game has already been played, and hence the message should be removed.

The service preferably allows communal posting, retrieval and updating of information associated with geographical places. This information may also include information about the relative distance of social network members from a given tagged location.

The described embodiment is in some aspects similar to services where messages may be left for one's social network. It combines IM (internet messaging) presence aspects with the social network elements of recommendations and the reputation of those making the recommendation, analysis or observation. The exemplary embodiment of the service extends and leverages the social tagging paradigm and tagging services previously described, such as those offered by Flickr™, del.ico.us™ and PubSub™ for geographic location.

FIG. 2a is a block diagram of content or contextual server 204 when configured in accordance with one embodiment of the invention. The microprocessor 252 is coupled to memory unit 260 via a bus 250. The Bus 250 additionally couples an input system 262 (e.g., network operator provisioning or configuration station), associated display system 264 and network interface 266 to the microprocessor 252. The memory unit 250 typically includes high speed storage elements including random access memory (DRAM, SRAM), read-only memory (ROM) as well as other memory systems including flash memory and disk drive storage.

During operation, software instructions stored on memory unit 260 in the form of one or more computer programs are applied to the microprocessor 252 (which also may contain its own internal program/data/cache memory) which in turn controls input system 262, display system 264 and network interface 266. The display system 264 and input 262 are typically used to configure and control the server. Messages and data are exchanged with other systems (whether local or remote) via one or more network interfaces 266. The software instructions control the various systems and causes message and data to be generated in accordance with the various descriptions and processes described throughout the application. Separate dedicated ICs or ASICs may also be used for one or more of these functions, such as where a separate network processor (NP) chipset or suite is used in conjunction with the aforementioned network interfaces and an installed networking or internetworking protocol stack. For example, the server may include an Ethernet/GBE/10-GigE (10/100/1000/10000) protocol stack and interface, Firewire (IEEE-1394) interface, USB interface, and so forth depending on the desired configuration and functionality of the server. The server may also be fitted directly with a wireless interface, either directly or indirectly, such as via a cellular MSC, or internetworking function (IWF). Hence, any modality which can timely deliver the relevant messages to the user can be used consistent with the invention, with “in band” cellular-based delivery being only one of a number of different possibilities.

### Methods

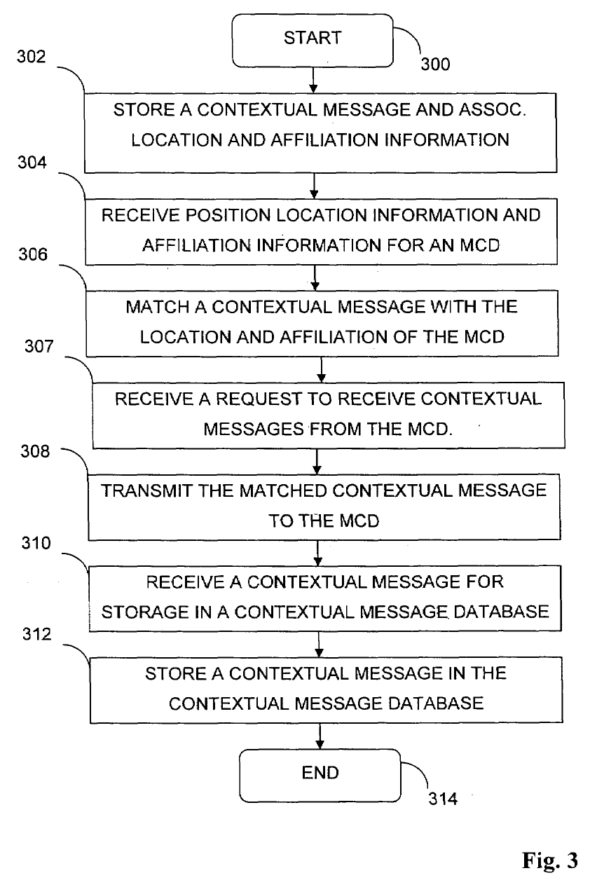

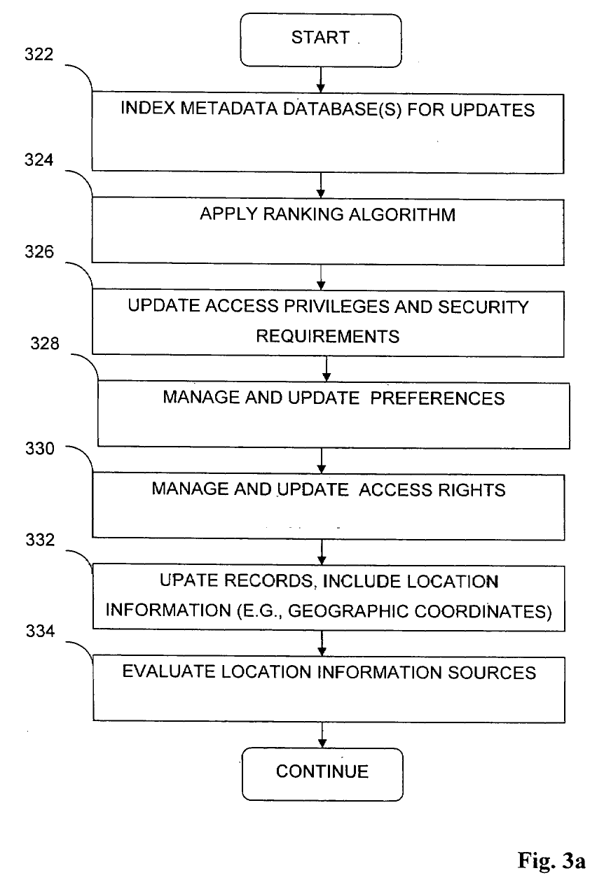

FIG. 3 is a flow chart illustrating the operation of the server 204 in accordance with one embodiment of the invention. The process begins at step 300, and at step 302 the server performs the step of storing one or more contextual messages and associated location and affiliation information. The contextual message(s) is/are preferably stored in a contextual message database. The server may also store other information about the messages including the provenance, time of entry, type or genre (test, audio, visual, etc.), message size in Kb or Mb, network routing information, associated encryption/decryption keys (e.g., public/private key pairs), digital signatures, descriptions of encoding for the message or its attachments (e.g., Real, AVC, MPEG-2, etc.), and so forth.

At step 304, the server 204 receives position location information (and affiliation information as required) for an MCD. Note that as used here, the term “MCD” may include one or multiple MCDs; the information need not be processed on a per-MCD basis where one or more common parameters (e.g., common membership in a delivery group, service providers, filters/masks, etc.) exist between the MCDs.

The information may be received in many ways including, but not limited to, by way of messages from the MCD 200 or from the particular access point with which the MCD is communicating. The server 204 may also receive information by retrieval from a database including an affiliation database for a set of MCDs. The database may be local or remote and may be identified by the MCD in some instances.

Remote or secondary sources of position location information may also be used, such as where a remote satellite network provides information about subscribers via a satellite or terrestrial data channel. This approach provides substantial independence between the MCD location and the subscriber network; e.g., in cases where the subscriber network may not have the capacity to perform or transmit position location information.

At step 306, the server 204 matches the location and affiliation of a contextual message with the current location and affiliation of the MCD. That is, the server identifies one or more contextual messages in its contextual message database with the same affiliation and location specification as that of the MCD(s) currently being processed.

At step 307, the server 204 receives a request to receive contextual message from the MCD. This is typically generated by the MCD and transmitted to the server via the wireless interface, although, this step may be automated or accomplished via a server initiated process. For example, one alternate embodiment comprises the MCD or access node (e.g., cellular base station, WiFi AP, etc.) periodically transmitting “location” information to the server 204, and the server analyzing this information to identify contextual matches. Upon detecting a match and hence download opportunity, the server 204 may then initiate a downstream message to the MCD (or base station, AP, etc.) to alert the user to the presence of the message(s). This can be a separate textual or other message, pop-up window, or simply signaling (e.g., such as where an icon on the user's display is illuminated, begins blinking, etc.) or another GUI or audible mechanism of the type well known in the art.

The aforementioned MCD-initiated request may include a particular set of affiliations for which message are being requested.

At step 308, the server 204 transmits the matched contextual message(s) to the MCD (subject to any filtration or masking). Ideally, the filtration or masking is applied at the server end (thereby mitigating wasted downstream communications bandwidth), although such processing can be applied at one or more intermediary nodes of the network (e.g., at the AP), or at the MCD itself.

The user may then view the message(s) using the MCD. In some cases, step 308 is performed in response the request received in step 307. When that request contains particular affiliations or other masking criteria, only the contextual messages matching those affiliations or criteria are transmitted. In other embodiments of the invention the message are transmitted automatically without receipt for a request. In still other embodiments of the invention there may be some “requestable” messages and other automatic messages stored by server 204.

At step 310, the server may optionally receive another contextual message for storage in a contextual message database. The contextual message will preferably include an associated location and affiliation which will also be stored in the contextual message database along with any other meta-data such as provenance, time of entry, etc. The contextual message may be generated by an MCD user (e.g., a reply or “bounceback” message, or unique user-generated message) or it may be received from another entity for distribution to other users. For example, an entity associated with any of the various messages services (directions, restaurant review, etc.) described throughout this application may provide contextual messages to the server 204 for delivery to other users. At step 312, the server 204 performs the step of storing the contextual message in the contextual message database. The process terminates at step 314.

By matching contextual messages and MCDs by location and afflation, and transmitting those messages to the MCD, the process shown in FIG. 3 advantageously allows users to receive user information based on context. Furthermore, the process allows a service to be provided whereby a virtual message “cloud” is associated with a given location (whether such location is stationary, moving, changing in character or composition, etc.). By controlling for affiliation, users are more likely to receive message that are useful to them, and the opportunity for subscription-based messaging services is created.

While the embodiment of the invention described in FIG. 3 matches contextual messages and MCDs 200 for both for location and affiliation, other embodiments of the invention may match for location or affiliation only, or one or more of these attributes with other attributes with other parameters.

In accordance with another embodiment of the invention, the server 204 may operate in accordance with the following steps (FIG. 3a). The first step 322 comprises the ongoing indexing of available metadata databases so as to provide updated information. Next, a ranking algorithm or other such mechanism is used (step 324) to present results in a specified order or format; e.g., in the order of relevance based on requesting user, as well as other parameters (e.g., conditions associated with the relevant business model(s) used for public message contributors such as advertisers, governments, public association, universities and individuals).

Next, in step 326, access rights and security aspects relating to the message(s) are managed and updated as required. For example, user authentication rules or protocols are implemented, messages encrypted or public/private key pairs, digital IDs, etc. issued, and so forth. Preferences of entities using the service are then managed and updated (step 328), and any access or other rights associated with messages that are in the purview of the service are managed (step 330). This step 330 may include for example access preferences imposed by a receiving entity, while step 326 primarily takes into consideration the entity originating the message.

Data records are then updated, and geographical coordinates when the message is created or edited in real-location/time is included (step 332). Identification of best available geographical location technology can also be conducted if desired (step 334), such as where an algorithm is used to evaluate or determine the highest accuracy or least-bandwidth-consumptive approach available for use by the service.

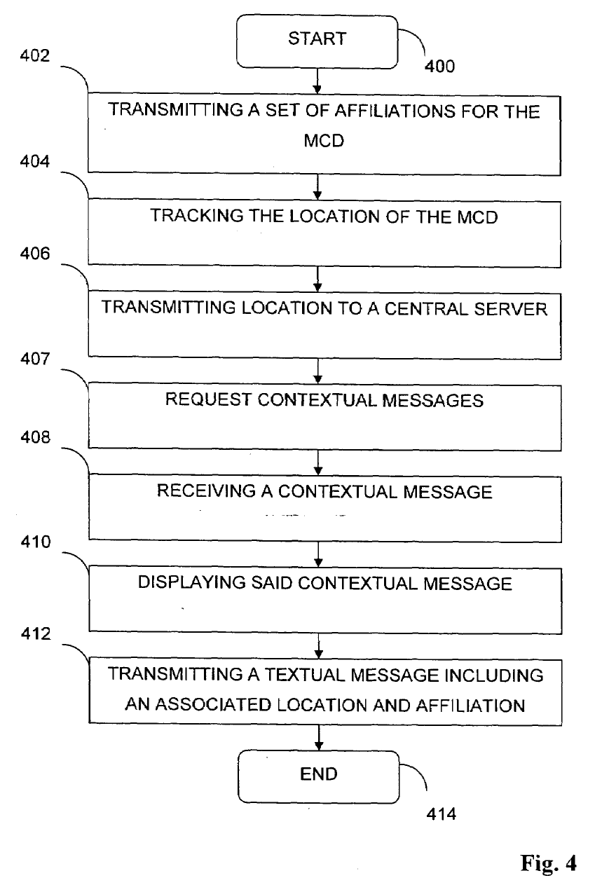

FIG. 4 is a flow chart illustrating the steps performed by an MCD 100 in accordance with one embodiment of the invention. The process begins at step 400, and at step 402 the MCD transmits a set of affiliations for the MCD. Alternatively, the affiliations may be maintained in a remote database for use by other systems or at the server where it is periodically updated.

At step 404, the location of the MCD is tracked. Various methods for performing position tracking have been described throughout this application, but typically this tracking uses GPS tracking services, triangulation, membership in an ad hoc network, etc. the use of each which is well known in the art.

At step 406 the location is transmitted to the central or context server. This could take place, for example, periodically or after a sufficiently large change in location has occurred, so as to minimize processing overhead and communication bandwidth requirements.

At step 406, the location is transmitted to a central server 204 via the wireless interface. At step 407, the MCD transmits a request to receive contextual message. In some instances this message will include affiliation or category information. This message is typically transmitted in response to user input, but may also be generated automatically based on user preferences. In other embodiments of the invention (see prior discussions of various message delivery protocols), no request may be generated.

At step 408, the MCD receives one or more contextual messages and at step 410, the MCD displays or otherwise processes (e.g., filters, stores, decrypts as required, encodes/decodes, etc.) the contextual message.

At step 412, the MCD performs the step of transmitting a new textual message. The new textual message may include an associated location, provenance, affiliation and type, or some combination thereof. This new message is typically generated by the user using one of the MCD input devices and may be a comment about a particular location made to the user's social network.

By performing the steps described above, a virtual message cloud is created around various geographic or other “locations”. Users who enter this message cloud will receive messages based on their location and affiliation and thereby receive useful and timely information about their surroundings. User may also add new messages to this virtual message cloud thereby increasing the total amount of information that is available (e.g., posting in a bulletin-board like fashion if desired). Also, users of a particular social network service may exchange location-based messages with one another thereby facilitating a higher level of communication (and communication density per unit time).

The virtual cloud or box created around various location described above can selectively be made accessible to all users, or it can be restricted to a subset of users, like those included in one or more of the user's “buddy” lists (as in the instant messaging services like MSN™ messenger) and to a specific set of tags that a user may define. For example, if a user's tag is plumbers, it may not be desirable to deliver messages associated with that tag to users who have set restaurants as their preference, but alternatively may be desirable to deliver such messages to users who have selected as a preference access to all tags.

The link between a given virtual cloud or box and the relevant geographical or other type of “location” location is defined by any number of location based technologies such as without limitation cellular site or “cell” ID, GPS, Assisted GPS, Enhanced 911 (in the U.S.), E112 (in Europe), Time of Arrival (TOA), Time Difference of Arrival (TDOA), Observed Time Difference (OTD) and Angle of Arrival (AOA). These technologies are currently being deployed and are ensured to be widely deployed given that governments throughout the world are making such deployment mandatory in many cases. However, it will be recognized that other techniques (including those not yet developed or deployed) may also be used consistent with the invention.

In the exemplary embodiment, the location data or information becomes metadata associated with the relevant virtual cloud or box. Such metadata advantageously allows indexing, search and delivery functions to be performed by the service provider or another entity (e.g., third-party operator).

Moreover, it is significant to note that several message “clouds” can co-exist at the same location if desired. For example, a first virtual cloud for users meeting Criterion A, a second cloud for users meeting Criterion B, etc. may be created. Some users meeting Criterion A may also meet Criterion B, and hence can access both clouds.

In accordance with one embodiment of the invention, the subset of persons associated with a virtual cloud or group is defined and managed either from the MCD, the server 204, or any device connected to the service on the Internet. Moreover, the user can choose the accessibility of a given tag or type of tag. If the grouping function G(S)Σ is defined to be the set of all possible users given access to a given tag, then there are G(S)ₙ possible subsets (including G(S)Σ) that can be defined by the user to limit access to the tag, where n=group or subset number. For example, subset G₃ (n=3) can be the user's travel social network, while subset G₁₀ (n=10) may be their Jabber IM service buddy-list. The user would be able to check off (e.g., via a list) of subsets he/she gives access to, as well as the tag search preferences allowed. The user could also even select individuals of a given subset.

In accordance with one embodiment of the invention, a user will enter a region (R) having set preferences for the type (or affiliation) of messages he/she wishes to receive, the preferences for their provenance (from which social network, individuals or other public source), and the degree of content received initially (Oust tags, the title or first line of the message, or the complete message). The user may then ask for additional parts of the message to be sent based on their browsing of the available messages. The user's preferences define the set G(R)ₙ for the jth user. As above, this user can define his preference to be allowed to see all tags available—G(R)_{Σ}. The union between: (i) G(R)ₙ, and (ii) the G(S)_{n,i} of all users i that have posted a message for the current location or region (R) of the user defining G(R)ₙ, produces the set G(D)ₙ of delivered messages (D). More generally:

G(R)ₙ|^{j}×G(S)_{n,i}=G(D)ₙ|^{j} Eqn. (1)

This approach allows the user to exclude or mask existing “clouds” since he/she will receive messages strictly relevant to their location at the moment. Because the system will generally know the user's current location via location reporting, the context server 204 will only deliver information for those messages relevant to the current location, with provenance from user's defined individuals, social networks or public sources as well as any preferences defined for the type of tags the user wishes to see.

If the user chooses to accept tags with provenance from public sources, some specific advertising messages relevant to the location or triggered by context of the presence of the individual at this location can be delivered. For example, information about the weather conditions at the location, the time of day, the attributes of the day (week end or week day) and season, local businesses, etc. could be used to deliver context relevant messages from friends or from advertisers. As noted above, information from the user's calendar and the contacts list of the device to make contextual decisions: For example the fact that a user is at this particular location to meet friends of business contacts can be used to push messages relevant to this context. At any time, the user can proactively decide via user input to have the message service active and if so, at what level of activity, or to “mute” it.

In accordance with another embodiment of the invention, when the user wants to leave messages relating to a particular location, he/she can connect to the context server 204 such as through the Internet, the GSM or CDMA voice network, WAP service, or the SMS number, to leave text, voice, video, image or voice content. These options are also available when the user desires to defer the creation, editing and uploading of content for a particular location to at time when the user is not at the location. The geo-location information can be entered manually along with the content created by the user, or a reply or “bounceback” approach of the type previously described used. There are today many electronic services, databases and maps available (e.g., navigation CDs, etc.) whereby the user can pinpoint the location being described.

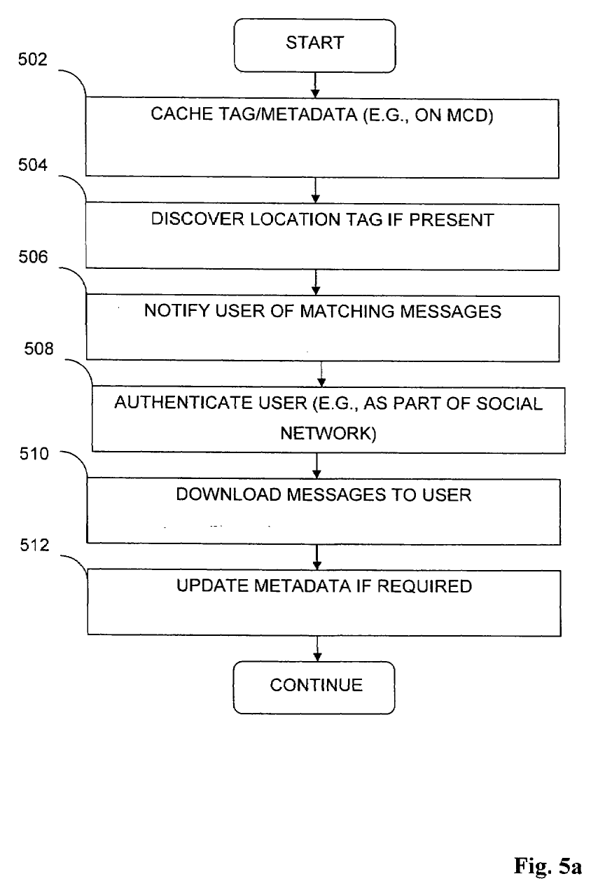

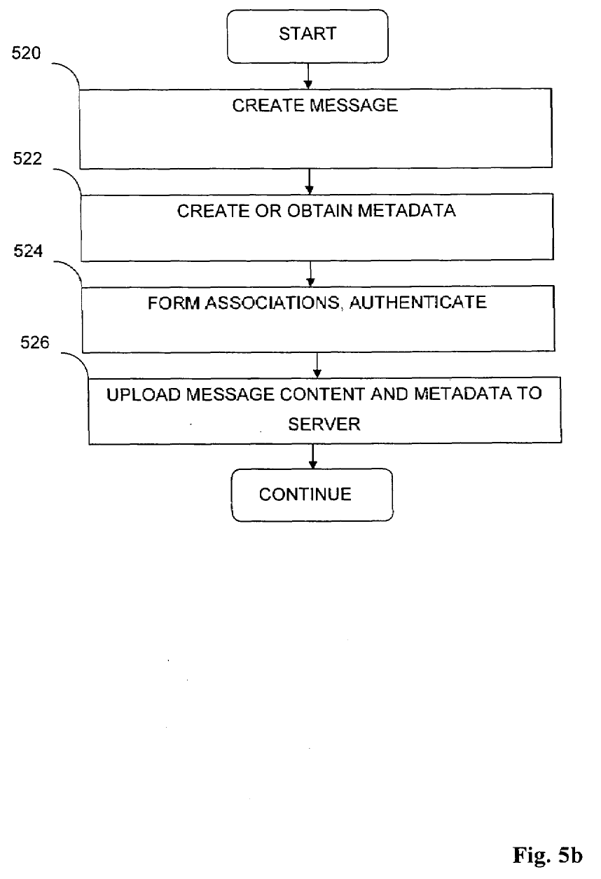

In accordance with still another embodiment of the invention, the following steps may be performed when existing tags are present (FIG. 5a). The first step 502 is the. caching of tag metadata on the user's device (e.g., MCD 100) upon entering a meta-area defined by a discrete location coordinate like a city or neighborhood. This step is followed by discovery of one or more specific location tags (step 504). This discovery process is typically performed by the context server 204 when comparing the tags of the MCD with the tags of a particular contextual message. This is followed by step 506, apprising the user of the availability of posted messages from one or more individuals, e.g., in a “buddy-list”, social networks to which the user adheres or other public source. That is, the user is notified that contextual messages are available that match the users location and affiliation.

This is followed by authentication of the user as being part of the social network (step 508) in the former case. Next, the information is downloaded in step 510 upon user authentication and/or accord. The tag is then updated in the case that the user wants to add new information regarding the location (step 512). In one embodiment the user generates his/her own message that is forwarded back into the contextual message database at the server 204.

The process may also be deferred when the user does not update in real-location/time, as previously described.

In accordance with another embodiment of the invention, the following step are performed when no tags are in existence (FIG. 5b). The first step 520 is creation of the message. This may be a real-location/time process, or alternatively a deferred process if not in real-location/time. This step is followed by metadata creation (step 522), which can include location information that is automatically added if in real-location/time, or alternatively user-coded (e.g., manually entered or selected) if deferred. Similarly, a user-created tag or tags can be included, whether in real-location/time, or deferred.

Next, the social network(s) and/or individuals to which the user desires to associate the message are authenticated per step 524. As above, this process may be performed in real-location/time or deferred.

The message metadata and payload are next uploaded to the context server 204, such uploading which can be performed in real-location/time or deferred as desired (step 526).

It will also be recognized that the method and apparatus described in co-pending U.S. patent application Ser. No. 11/317,473 filed Dec. 22, 2005 entitled “Methods And Apparatus For Organizing And Presenting Contact Information In A Mobile Communication System”, previously incorporated by reference herein, may be used consistent with the present invention. These methods and associated apparatus provide enhanced user contact and preference management and display in a mobile communications environment. In one embodiment, a mobile network and associated user or client devices (e.g., cellular phones, PDAs, etc.) are configured to provide each mobile user with highly relevant and timely information regarding that user's contacts, family, “buddies”, and locations of interest. The invention advantageously displays this information in an easy-to-use and readily perceived format, thereby overcoming the disabilities of prior art menu-based and “rolodex” contact management systems. Multiple functions can also be invoked using this display format, such as initiating a communication channel (e.g., cellular phone call), contact status determination, and indication of physical or geographic proximity.

The aforementioned display format is also “scale agnostic” in the sense that it can accommodate contacts or clusters at a variety of different physical locations without the scale-related issues pervasive in prior art map-based solutions.

The present invention can also be adapted to make use of the concept of “proximity”. While one specific instance of proximity comprises determination of a physical or actual distance as previously described, the invention is equally applicable to use of cognitive or psychographic proximity, such as where the “closeness” of something perceived by the user is defined in other terms. For example, a user might consider their family members very cognitively proximate (they see them and talk with them frequently), yet these family members may be physically disposed at any number of distances from the user's location. This expansive definition of proximity provides the invention with many different ways of describing, categorizing and delivering messages, thereby giving the user a high degree of flexibility in their delivery preferences.

The foregoing methods and apparatus can also be used to leverage the inductive or “pattern recognition” capabilities of the human mind to provide the user with a memorable and simple, yet powerful display paradigm that also obviates much manual (e.g., key panel) data entry associated with prior art mobile device information management and messaging systems. Pre-stored messages of certain “themes” can be used, and even associated with certain actual (absolute), relative, or logically proximate “locations” stored within the MCD or other device.

“Clustering” is also optionally employed within the invention. Clusters comprise a set of contacts or entities grouped in accordance with a categorization or association scheme. Subgroups and structure within one or more dimensions of interest (e.g., physical location or cognitive/psychographic factors) can accordingly be identified, and used as a basis for message delivery. For example, when a given user is within the location and affiliation target parameters, message delivery may occur to that user, as well as his/her cognitively or logically proximate members (e.g., classmates, buddies, family members, etc.), irrespective of their location(s).

Thus, methods and apparatus for gathering and delivering context information in a mobile communication system have been described. Many other permutations of the foregoing system components and methods may also be used consistent with the present invention, as will be recognized by those of ordinary skill in the field.

### Users and Business Models

Various types of users will also be able to take advantage of the benefits provided by the above described aspects of the invention. For example, the service provides an ideal forum for local advertising. A merchant in a given geography can provide information to users willing to accept it about their products and services, as well as time-sensitive (real-time) updates on specials, sales, limited time or duration occurrences, etc., and can provide multimedia content as well as coupons that the user can use for preferential prices and other advantages if said user decided to frequent the advertising merchant. For example, in exemplary business model, the advertiser and the service provider have an agreement wherein the advertiser pays the service provider for each delivered (or viewed) message within a given “location” by the service provider's subscribers, somewhat akin to “per click” advertising on the Internet.

Another prospective business model for this type of use would comprise one where advertisers purchase a given radius centered on a geographical coordinate (or even a moving location, such as a tour bus or boat that makes harbour cruises or the like). Furthermore, bidding for placement in the order that the metadata about messages is provided to the user who has allowed this type of information to be displayed in his profile could be used, either alone or in conjunction with the foregoing.

One type of potential user of the described service(s) is the so-called “core” user. In the present context, a core user comprises a user who subscribes to the service. The user is expected to be primarily a consumer of information as, in certain cases, an editor or even supplier of limited amounts of personal or context-specific information.

Another type of user of the service is the “recommender”. The recommender is a special case of the user; i.e., is more disposed to creating new messages and editing existing messages, but less predisposed to consuming messages. The business model used for such recommenders will typically be the same as the one for the core user, although it will be appreciated by those of ordinary skill that other business models (including those tailored to or customized for the recommender's profile) may be used as well.

Another possible class of user is the “institutional” user. The institutional user may be a non-profit institution, government entity, health care system, etc. that will pay a subscription fee, typically tiered for the size of the radius and/or the number of locations covered. There may also be some preferential treatment for those institutions providing high-value content. In this area, there are potentially partnership opportunities for the network or service provider with special content providers such as, say, museums.

Likewise, the foregoing institutional users may also comprise content or advertising sources as well as users, such as where messages pushed to the context server 204 are generated by the same entity which also maintains a subscription with the service provider. For example, a health care provider (e.g., hospital) may have a subscription for its location, wherein patients or visitors of the hospital can selectively receive targeted advertising, useful content, etc., while at the same time the hospital can push advertising or other messages to the same or other locations (e.g., places such as doctor's offices, pharmacies, etc.) where people might find such messages useful.

It will be recognized that while certain aspects of the invention are described in terms of a specific sequence of steps of a method, these descriptions are only illustrative of the broader methods of the invention, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

What is claimed is:

1. In a mobile communications network, said network including a contextual message server and a mobile communications device (MCD) communicating with said contextual message server via at least a wireless link, a method of operating the mobile communications network comprising:
detecting a location and an affiliation of said mobile communication device;
identifying contextual messages in said contextual message server having location and affiliation parameters that match said detected location and affiliation, thereby generating a set of identified contextual messages; and
transmitting said set of identified contextual messages from said contextual message server to said mobile communication device.

2. The method as set forth in claim 1, wherein said affiliation includes membership in a social network.

3. The method as set forth in claim 1, wherein said affiliation comprises a subscription to a restaurant review service.

4. The method as set forth in claim 1, wherein said affiliation comprises selection of a historical information tour.

5. The method as set forth in claim 1, wherein said affiliation is determined based at least in part on a tag.

6. The method as set forth in claim 1, wherein said contextual message server stores the affiliations of a plurality of mobile communication devices associated with respective ones of different users of said mobile devices.

7 The method as set forth in claim 1, wherein said mobile communication device stores at least one affiliation, and wherein said mobile communications device is further adapted to transmit said at least one affiliation to said contextual message server.

8. The method as set forth in claim 1, wherein said act of identifying is performed by determining if the location of the MCD is within a prescribed distance of the location associated with said contextual message.

9. The method as set forth in claim 8, wherein said prescribed distance is specified by said user via input into said MCD.

10. The method as set forth in claim 1, further comprising transmitting a request from said MCD to said contextual message server, said request including an affiliation, and said request indicating that said contextual message server should send any contextual messages to said MCD that have the same location and affiliation.

11. The method as set forth in claim 1, wherein said act of identifying is performed by determining if the location of the MCD is within a prescribed geographic area of the location associated with said contextual message, said geographic area being irregular in shape.

12. A method for operating a contextual message server in a network that includes a wireless link to a mobile communication device, said method comprising:
storing a contextual message, and an associated message location and affiliation for said contextual message;
receiving mobile communication device location and mobile communication device affiliation information;
evaluating said message location and affiliation with said mobile communication device location and mobile communication device affiliation; and
transmitting said contextual message to said mobile communication device via said wireless link.

13. The method as set forth in claim 12, wherein said mobile communication device location and mobile communication device affiliation information is received by said server from a proxy of said mobile communication device.

14. The method as set forth in claim 12, wherein said mobile communication device location and mobile communication device affiliation information is received from said mobile communication device by way of a wireless network.

15. The method as set forth in claim 12, further comprising:
receiving a new contextual message from an external source, said new contextual message having associated location and affiliation information; and
storing said new contextual message for comparison with future mobile communication device location and affiliation information.

16. The method as set forth in claim 15, wherein said external source comprises a second mobile communication device.

17. The method as set forth in claim 15, wherein said external source comprises is a social networking service.

18. The method as set forth in claim 15, wherein said contextual messages include metadata, said metadata comprising at least one of: (i) provenance information, and (ii) time of creation information.

19 The method as set forth in claim 18, wherein said external source comprises a restaurant guide service.

20. The method as set forth in claim 18, wherein said external source comprises a historical information service.

21. The method as set forth in claim 12, wherein said act of evaluating comprises matching at least portions of said message location and affiliation with said mobile communication device location and mobile communication device affiliation; and
said matching is performed by determining if the location of the MCD is within at least one of: (i) a prescribed distance of, and (ii) a designated irregularly shaped area of, the location associated with said contextual message.

22. The method as set forth in claim 12, wherein said location is received from an MCD directly or indirectly via a wireless cellular interface.

23. The method as set forth in claim 12, further comprising transmitting a request from said MCD to said contextual message server, said request including an affiliation, and said request indicating that said contextual message server should send any other or subsequent contextual messages to said MCD that have the same location and affiliation.

24. A method for operating a mobile communications device (MCD), comprising:
determining a location associated with the mobile communications device;
transmitting the location via a wireless interface to a message server; and
receiving a message from said server based at least in part on said location and an affiliation of said mobile communication device.

25. The method as set forth in claim 24, wherein said mobile communications device stores said affiliation and transmits said affiliation to said message server.

26. The method as set forth in claim 24, wherein said location comprises a proximity to a substantially mobile reference point.

27. The method as set forth in claim 24, wherein said affiliation is stored on a server remote from MCD.

28. The method as set forth in claim 24, wherein said affiliation comprises membership in a social network.

29. The method as set forth in claim 24, wherein said affiliation comprises a subscription service.

30. The method as set forth in claim 24, wherein said message comprises a contextual message, and said MCD further transmits a request to receive said contextual message in response to input from a user of said MCD.

31. The method as set forth in claim 30, wherein said request includes affiliation information.

32. The method as set forth in claim 24, further comprising transmitting a distance preference, said distance preference indicating a threshold distance within which said MCD should receive said message.

33. The method as set forth in claim 24, wherein a user of said MCD determines preferences for (i) the type of messages it wishes to receive, (ii) the for the provenance of the messages, and (iii) the extent of content received initially.

34. A communications network for delivering contextual messages, comprising:
contextual message server apparatus adapted to:
store contextual messages and location and affiliation information associated therewith;
receive mobile communication device (MCD) location information;
match contextual messages to said MCD location information; and
transmit matched contextual messages; and
at least one MCD adapted to:
interface with said contextual message server via a wireless link;
determine said MCD location information;
transmit said MCD location information to said contextual message server apparatus; and
receive said matched contextual messages from said server apparatus.

35. A mobile communications device (MCD) adapted for at least receiving contextual messages, said mobile communication device comprising:
wireless interface apparatus adapted to communicate data with at least one other device;
a memory for storing software instructions;
a microprocessor in data communication with said memory and adapted to execute said software instructions, and control said wireless interface apparatus;
wherein said software instructions:
cause location information to generated, and
cause said device to receive messages having at least location information that matches that of said generated location information.

36. The device of claim 35, wherein said device comprises location apparatus adapted to produce said generated location information, and said device is further configured to transmit said generated location information to a message server.

37. The device of claim 35, further comprising at least one affiliation.

38. The device of claim 37, wherein said messages comprise contextual messages, the context of which is determined based at least in part on said generated location information and said affiliation.

39. The device of claim 38, wherein said generated location information comprises the geographic location of the mobile communication device.

40. The device of claim 36, wherein said location apparatus comprises ranging apparatus adapted to determine proximity of said MCD to at least one of a fixed or moving location.

41. The device of claim 36, wherein said location apparatus comprises a satellite-based transceiver.

42. The device of claim 35, wherein said wireless interface apparatus is adapted to communicate data with said at least one other device, said at least one other device being adapted to determine the location of said MCD based on said communication of data.

43. The device of claim 42, wherein said at least one other device comprises a wireless network node, and said determination of the location of said MCD comprises determining membership in an ad hoc wireless network.

44. The mobile communications device (MCD) of claim 42, wherein said at least one other device comprises a cellular network base station or mobile switching center (MSC).

45. A contextual message server for storing contextual messages, said contextual message server comprising:
memory configured to store software instructions;
a microprocessor in communication with said memory and configured to execute said software instructions, wherein said software instructions cause said microprocessor to:
maintain a database of contextual messages and associated locations and affiliations;
receive mobile communication device location information;
determine an affiliation for at least one mobile communication device for which said location information has been received;
identify at least one message from said database based at least in part on said affiliation and said location information; and
transmit at least a portion of said at least one matching message to said at least one mobile communication device.

46. The server of claim 45, wherein said affiliation comprises a search term, and said identification of said at least one message comprises identifying said at least one message via said search term matching metadata associated therewith.
